(19) United States
(12) Patent Application Publication
(10) Pub. No.: US 2022/0231433 A1
(43) Pub. Date: Jul. 21, 2022

(54) CABLE CONNECTOR FOR DECREASING SIGNAL RETURN LOSS

(71) Applicant: Signal Cable System Co., Ltd., Yilan County (TW)

(72) Inventor: Jui-Huang CHUNG, Yilan County (TW)

(73) Assignee: Signal Cable System Co., Ltd., Yilan County (TW)

(21) Appl. No.: 17/220,552

(22) Filed: Apr. 1, 2021

(30) Foreign Application Priority Data
Jan. 20, 2021 (TW) 110200711

(51) Int. Cl. H01R 4/48; H01R 13/15

(52) U.S. Cl. CPC H01R 4/4818; H01R 13/15

(57) ABSTRACT

A cable connector for decreasing signal return loss includes a front cap, a base, and a connecting terminal. A first hole is formed on the front cap, and a second hole is formed on the base. A second front side of the base connects to a first back side of the front cap. The connecting terminal includes an elastic clamping part, a wire connection part, and a lead part. A back side of the clamping part is a free end, and a front side of the clamping part is connected to the wire connection part. The lead part is mounted in front of the wire connection part. The connecting terminal is mounted in the base, and the lead part pierces the front cap covering the connecting terminal through the first hole. The present invention prevents capacitance in the cable connector, and improves electric signal transmission efficiency.

### CROSS-REFERENCE TO RELATED APPLICATIONS

This application claims the priority benefit of TW application serial No. 110200711 filed on Jan. 20, 2021. The entirety of the above-mentioned patent application is hereby incorporated by reference herein and made a part of specification.

### BACKGROUND OF THE INVENTION

### 1. Field of the Invention

The present invention relates to a cable connector, and more particularly a cable connector for decreasing signal return loss.

### 2. Description of the Related Art

Electronics of all kinds are widely available in our modern daily lives. Between different kinds of electronics, a corresponding connector is needed to transmit signals between the electronics. As electronic devices improve in quality, so should connectors to ensure high quality signal transmission between the electronic devices. With reference to FIG. 14 and FIG. 15, a conventional cable connector 50 connecting a conventional cable connector head 60 is illustrated, and the conventional cable connector 50 can be found using in conjecture with a signal divider for devices such as a television.

The conventional cable connector 50 includes a connecting terminal 51, a base 52, and a front cap 53. The front cap 53 is connected with a front side of the base 52. The connecting terminal 51 further includes a body 511, a first elastic piece 512, and a second elastic piece 513. One side of the body 511 is mounted inside the base 52, and another side of the body 511 pierces through the front side of the base 52, piercing through and combining with the front cap 53. A front side of the first elastic piece 512 and a front side of the second elastic piece 513 are connected and mounted with a back side of the body 511, and the first elastic piece 512 and the second elastic piece 513 are located opposite to each other correspondingly. Furthermore, the first elastic piece 512 includes a first bending part 5121 and the second elastic piece 513 includes a second bending part 5131, wherein the first bending part 5121 and the second bending part 5131 press on each other elastically.

An opening 521 is formed on a back side of the base 52. A cable line 61 of the conventional cable connector head 60 is configured to be inserted through the base 52 via the opening 521 and inserted between the first bending part 5121 and the second bending part 5131. The first bending part 5121 and the second bending part 5131 would clamp and fix the cable line 61 in place, making the cable line 61, the first bending part 5121, and the second bending part 5131 all electrically connected. This allows a signal to be transmitted from the cable line 61 to the body 511 through the first bending part 5121 and the second bending part 5131, and then the body 511 outputs the signal.

However, a back-side-stretching and then front-side-bending structure of the first bending part 5121 and the second bending part 5131 creates resistance discontinuations along a signal transmission pathway, causing the first bending part 5121 and the second bending part 5131 to build up capacitance, resulting in signal return losses, and hindering effectiveness of the conventional cable connector 50.

### SUMMARY OF THE INVENTION

To overcome the drawback, the present invention provides a cable connector for decreasing signal return loss, improving upon the drawback of a conventional cable connector, wherein inside of the conventional cable connector a bending structure is prone to cause signal return losses. The present invention improves signal return losses by minimizing resistance discontinuations along a signal transmission pathway.

To achieve the aforementioned improvements, the cable connector for decreasing signal return loss includes a front cap, a base, and a connecting terminal. The connecting terminal is mounted inside the base, and the front cap is mounted on the base and the connecting terminal.

More particularly, the front cap has a first hole, a first front side, and a first back side. The base has a second front side and a second back side, wherein the second front side is connected to the first back side, and the second back side of the base has a second hole.

The connecting terminal includes a clamping part, a wire connection part, and a lead part. The clamping part has a front side and a back side, wherein the clamping part is elastic and the back side of the clamping part is a free end. The wire connection part also has a front side, and the wire connection part is connected to the front side of the clamping part. The lead part has a back side, is mounted on the front side of the wire connection part to connect the wire connection part, and is inserted through the first hole to extend out of the front cap.

When the cable connector for decreasing signal return loss of the present invention is connected with a cable, the cable would be able to be inserted through the base through the second hole. The cable is then fixed in place by the clamping part, causing the cable and the connecting terminal to electrically connect. An electric signal is then transmitted from the cable to the clamping part, through the clamping part to the wire connection part, and through the wire connection part to the lead part respectively, until eventually outputting the electric signal from the lead part.

Evidently, since the back side of the clamping part is the free end in the present invention, and without the bending structure of the conventional cable connector, compared with the conventional cable connector, the present invention is able to avoid capacitance built up in the bending structure, preventing a potential capacitor from interfering with signal transmissions between electronic devices, and increasing effectiveness of signal transmissions through the cable connector for decreasing signal return loss.

### BRIEF DESCRIPTION OF THE DRAWINGS

FIG. 1 is a perspective view of a first embodiment of a cable connector for decreasing signal return loss of the present invention.

FIG. 2 is a first exploded view of the first embodiment of the present invention.

FIG. 3 is a second exploded view of the first embodiment of the present invention.

FIG. 4 is a perspective view of a connecting terminal of the first embodiment of the present invention.

FIG. 5A is a cross-sectional view of the first embodiment of the present invention.

FIG. 5B is another cross-sectional view of the first embodiment of the present invention.

FIG. 6 is a plan view of a second back side of a base of the first embodiment of the present invention.

FIG. 7 is a perspective view of a first application of the first embodiment of the present invention.

FIG. 8 is a cross-sectional view, viewed from top, of the first application of the first embodiment of the present invention.

FIG. 9 is a cross-sectional view of the first application of the first embodiment of the present invention.

FIG. 10 is a perspective view of a second embodiment of the present invention.

FIG. 11 is an exploded view of a second application of the first embodiment of the present invention.

FIG. 12 is a perspective view of the second application of the first embodiment of the present invention.

FIG. 13 is a cross-sectional view of the second application of the first embodiment of the present invention.

FIG. 14 is a perspective view of a conventional cable connector.

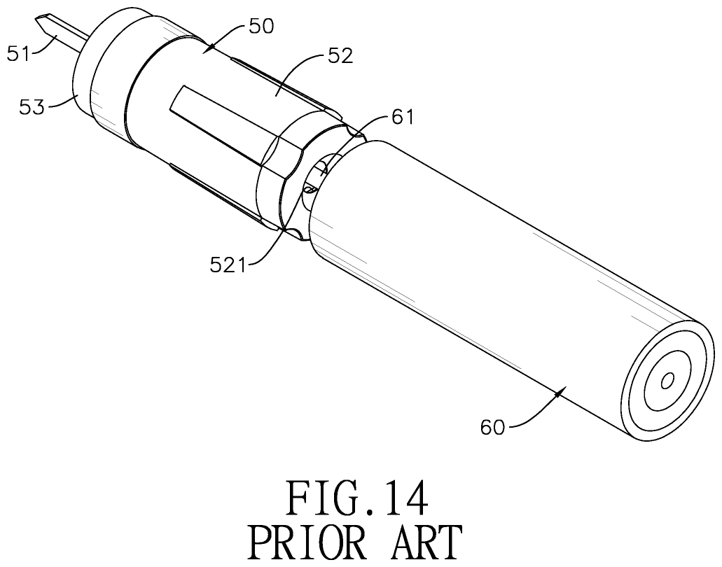

FIG. 15 is a cross-sectional view of the conventional cable connector.

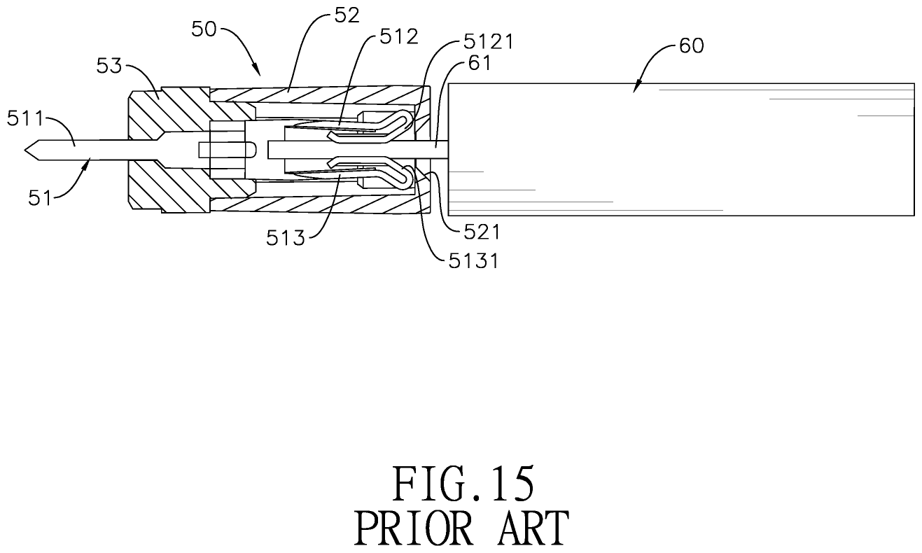

### DETAILED DESCRIPTION OF THE INVENTION

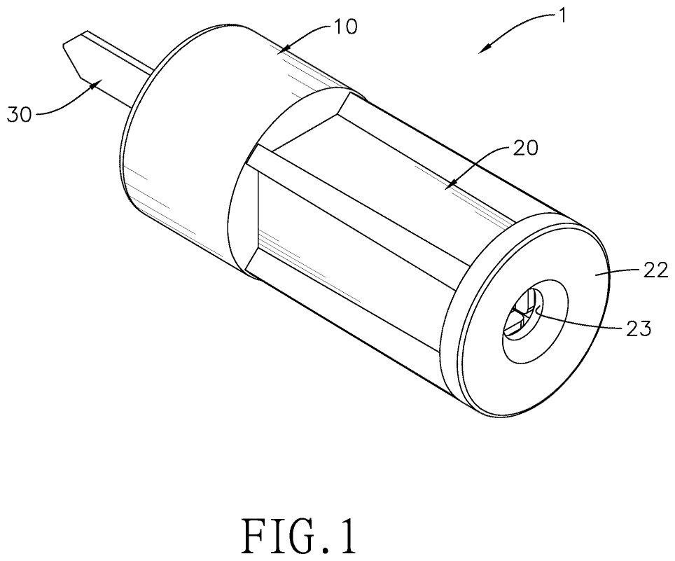

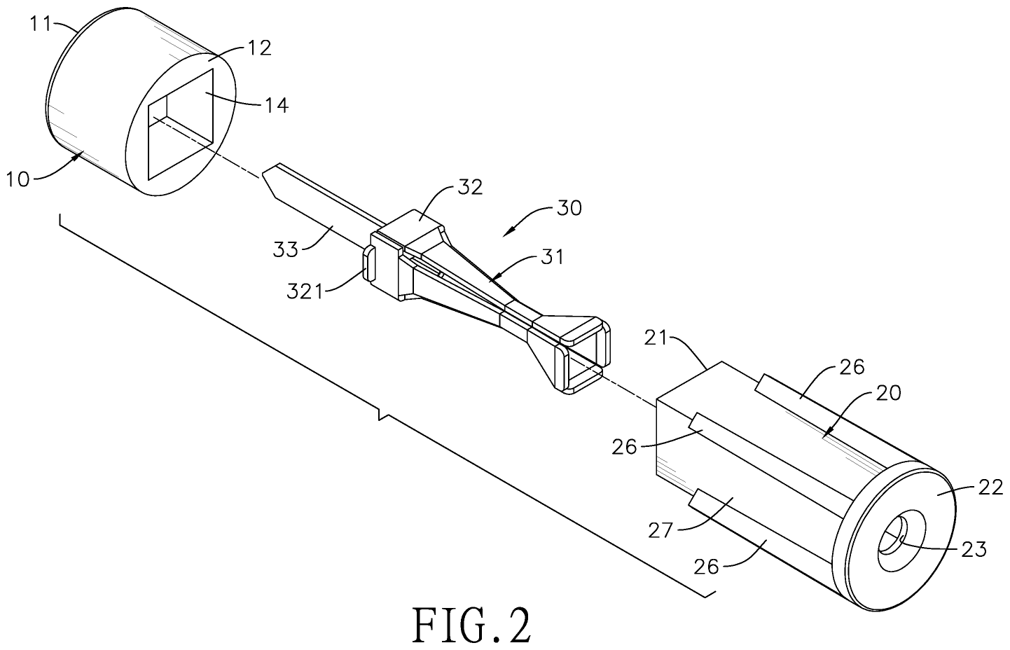

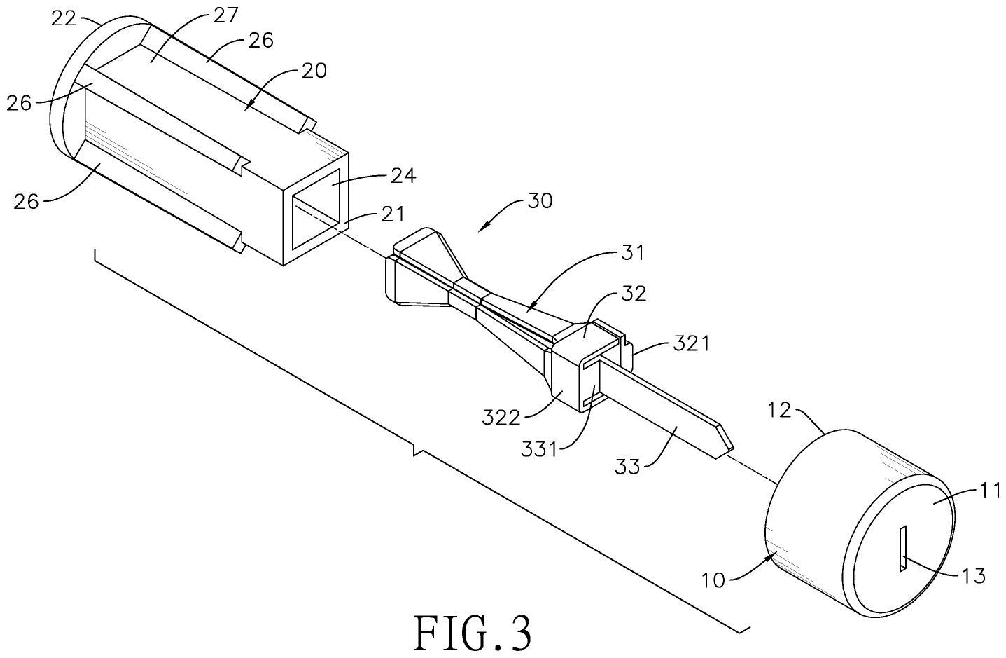

With reference to FIG. 1, FIG. 2, and FIG. 3, in a first embodiment of the present invention, a cable connector for decreasing signal return loss 1 of the present invention includes a front cap 10, a base 20, and a connecting terminal 30. The connecting terminal 30 is partly mounted inside the base 20 and partly pierced through the base 20. The front cap 10 is connected with the base 20, and the front cap 10 covers the base 20 and the connecting terminal 30. The cable connector for decreasing signal return loss 1 of the present invention is applicable to be used in conjecture with a signal divider for electronic devices such as a television, for transmitting electric signals between different electronic devices.

The front cap 10 has a first front side 11 and a first back side 12. A first hole 13 is formed on the first front side 11 of the front cap 10, and a first mounting recess 14 is formed on the first back side 12 of the front cap 10 for mounting the connecting terminal 30. The first mounting recess 14 is connected with the first hole 13. More particularly, the first hole 13 and the first mounting recess 14 extend from the first front side 11 of the front cap 10 to the first back side 12 of the front cap 10, and the first hole 13 and the first mounting recess 14 are also formed through a front surface and a back surface of the front cap 10. The front cap 10 can be manufactured with silicone, and in the first embodiment of the present invention the front cap 10 is in a cylindrical shape. The front cap 10 can be in other shapes in another embodiment of the present invention though.

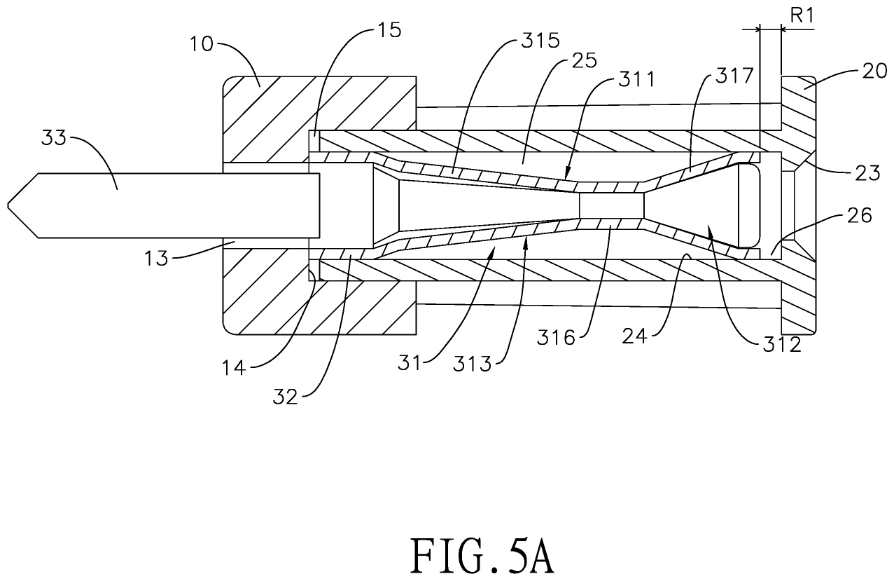

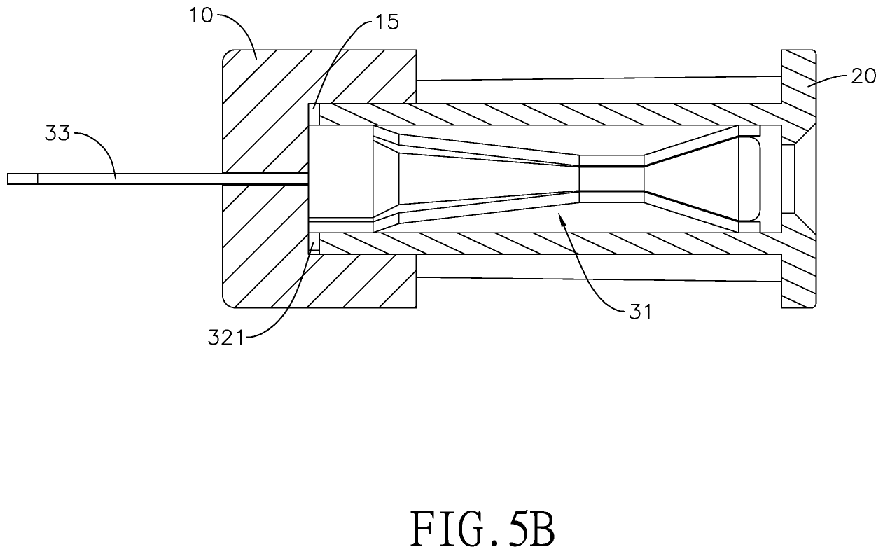

The base 20 has a second front side 21 and a second back side 22. A second mounting recess 24 is formed on the second front side 21 of the base 20 for mounting the connecting terminal 30, and a second hole 23 is formed on the second back side 22 of the base 20. The second hole 23 and the second mounting recess 24 extend from the second back side 22 of the base 20 to the first front side 11, wherein the second front side 21 of the base 20 is covered by the front cap 10, positioning the second front side 21 of the base 20 in the first mounting recess 14 of the front cap 10, and creating a mounting space 25 as shown in FIG. 5A as the first mounting recess 14 and the second mounting recess 24 connect. The mounting space 25 is therefore used to enclose the connecting terminal 30 between the front cap 10 and the base 20. The base 20 can be manufactured with Polypropylene (PP).

To generalize, a back side of the base 20, designated as the second back side 22, has the second hole 23, and a front side of the base 20 known as the second front side 21, is connected to a back side of the front cap 10 designated as the first back side 12.

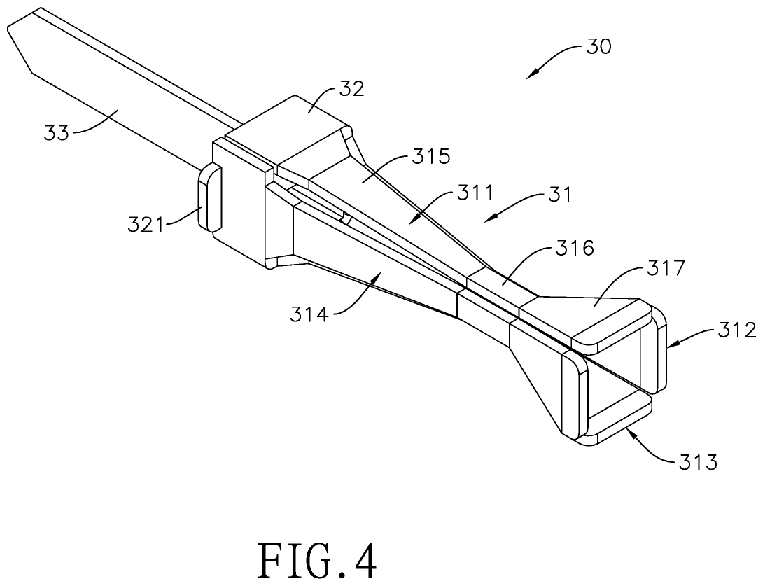

With reference to FIG. 4 and FIG. 5A, the connecting terminal 30 has a clamping part 31, a wire connection part 32, and a lead part 33. The clamping part 31 further includes a first clamping piece 311, a second clamping piece 312, a third clamping piece 313, and a fourth clamping piece 314, wherein the first clamping piece 311 and the third clamping piece 313 are located opposite to each other, and the second clamping piece 312 and the fourth clamping piece 314 are also located opposite to each other. The first clamping piece 311, the second clamping piece 312, the third clamping piece 313, and the fourth clamping piece 314 are separately mounted elastic pieces. Each of the first clamping piece 311, the second clamping piece 312, the third clamping piece 313, and the fourth clamping piece 314 respectively has a front part 315, a middle part 316, and a back part 317. The middle part 316 is connected with a back end of the front part 315, and the back part 317 is connected with a back end of the middle part 316; in other words, the middle part 316 is connected between the front part 315 and the back part 317. The middle part 316 is extendable from the front part 315 to the back part 317. A diameter of the front part 315 is bigger than a diameter of the middle part 316 and a diameter of the back part 317 is also bigger than the diameter of the middle part 316. More particularly, the diameter of the front part 315 gradually decreases from the wire connection part 32 towards the middle part 316, and the diameter of the back part 317 gradually decreases from the second hole 23 towards the middle part 316.

Furthermore, the front part 315 and the back part 317 are mounted at a tilting angle with respect to the middle part 316. The front part 315 tilts toward the middle part 316 from the wire connection part 32, narrowing towards a space surrounded by the middle parts 316 of the clamping pieces 311, 312, 313, 314 from a bigger space surrounded by the front parts 315 of clamping pieces 311, 312, 313, 314. In other words, a front space surrounded by the front parts 315 of the clamping pieces 311, 312, 313, 314 expands gradually from the middle part 316 towards the wire connection part 32. Similarly, the back part 317 tilts toward the middle part 316 from the second hole 23, narrowing towards the space surrounded by the middle parts 316 of the clamping pieces 311, 312, 313, 314 from a bigger space surrounded by the back parts 317 of the clamping pieces 311, 312, 313, 314. In other words, a back space surrounded by the back parts 317 of the clamping pieces 311, 312, 313, 314 expands gradually from the middle part 316 towards the second hole 23.

The clamping part 31 has a front side and a back side, the wire connection part 32 has a front side, and the lead part 33 also has a back side as well. The wire connection part 32 is formed on the front side of the clamping part 31, connecting with the front parts 315 of the clamping pieces 311, 312, 313, 314. The back parts 317 of the clamping pieces 311, 312, 313, 314 are free to move, in other words, the back side of the clamping part 31 is a free end, and therefore remains without bending. The wire connection part 32 is hollow and is located corresponding to the first mounting recess 14 of the front cap 10. When the connecting terminal 30 is mounted in the second mounting recess 24 of the base 20, the wire connection part 32 is mounted in the first mounting recess 14 and the second mounting recess 24, and the wire connection part 32 and the clamping part 31 are mounted inside the second mounting recess 24. With further reference to FIG. 5B, a locking part 321 protrudes from an edge of the front side of the wire connection part 32, and the locking part 321 is mounted between the front cap 10 and the base 20, creating a gap 15 between the front cap 10 and the base 20. By having the locking part 321, contact between the back side of the clamping part 31 and a bottom of the second mounting recess 24 is preventable, saving space for the clamping part 31 for any possible deformations. In the embodiment of the present invention, the wire connection part 32 can be in a hollow rectangular shape. The first mounting recess 14 of the front cap 10 and the second mounting recess 24 of the base 20 can also be rectangular mounting recesses, for containing the connecting terminal 30 within the first mounting recess 14 and the second mounting recess 24. The shape of the wire connection part 32 and the shape of the first mounting recess 14 and the second mounting recess 24 are free to change from the embodiment of the present invention. In another embodiment of the present invention, the back side of the clamping part 31 is free to move without contacting an inner surface of the second mounting recess 24.

The lead part 33 is mounted on the front side of the wire connection part 32, and in FIG. 3, a bending part from the back side of the lead part 33 is connected to the edge of the front side of the wire connection part 32 designated as a frontal edge 322. When the front cap 10 is covered on the connecting terminal 30, the lead part 33 pierces through the front cap 10 via the first mounting recess 14 and the first hole 13 of the front cap 10. The lead part 33 can be a flat piece, but can be in other shapes in other embodiments of the present invention.

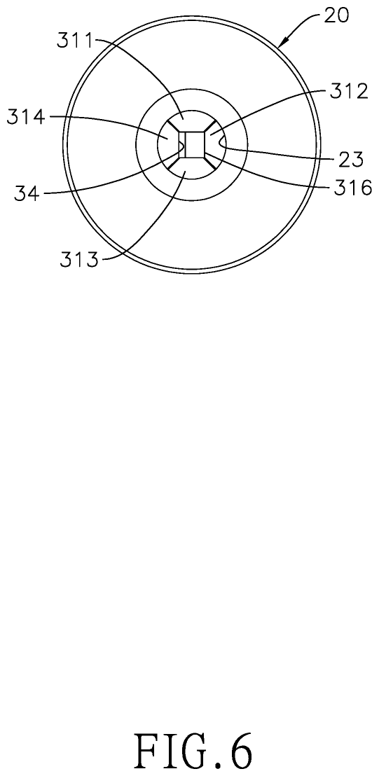

With reference to FIG. 6, the middle parts 316 of the clamping pieces 311, 312, 313, 314 correspondingly form a clamping hole 34, wherein the first hole 13, the first mounting recess 14, the wire connection part 32, the clamping hole 34, the second mounting recess 24, and the second hole 23 are aligned.

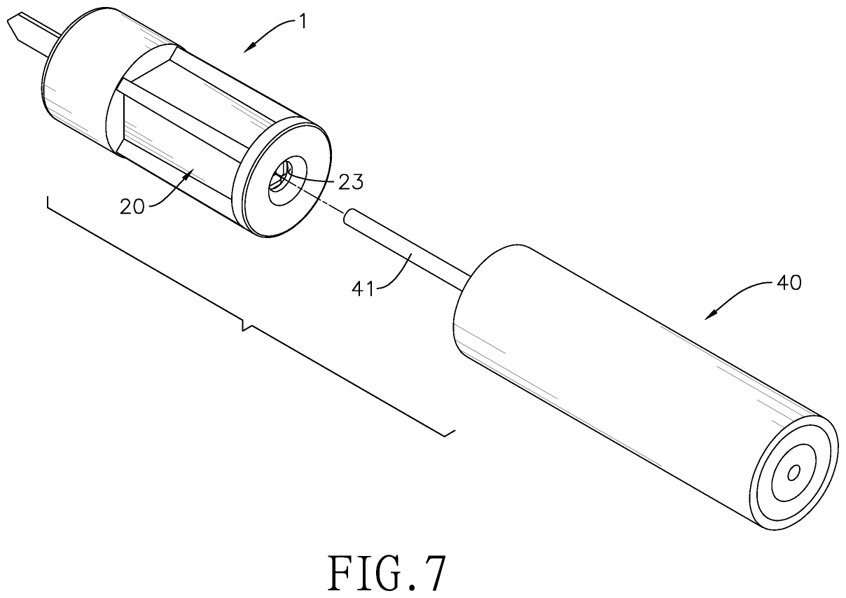

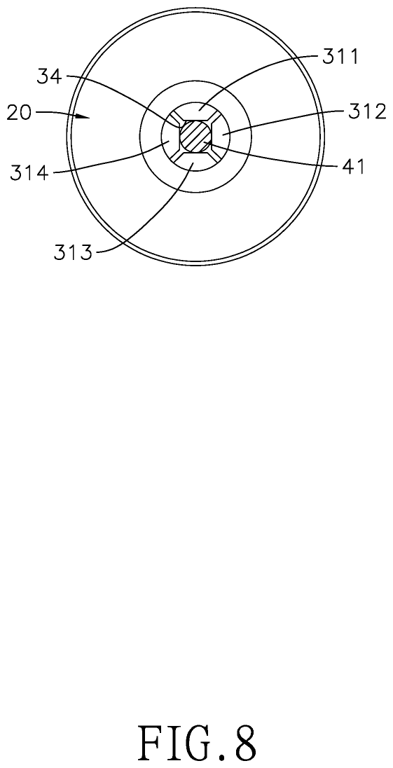

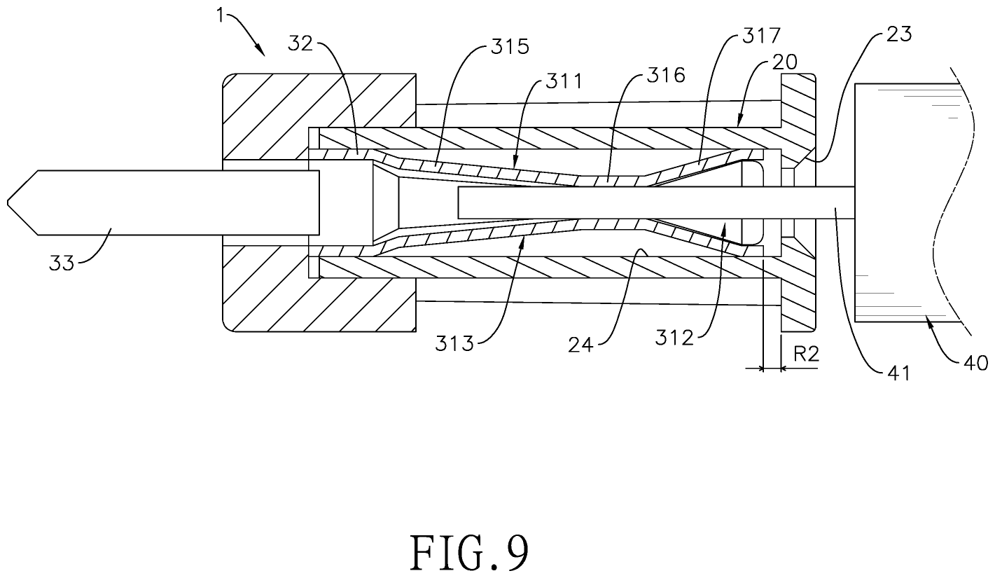

With reference to FIG. 3, FIG. 7, FIG. 8, and FIG. 9, in a first application of the present invention, the cable connector for decreasing signal return loss 1 of the first embodiment of the present invention can be connected to a cable connector head 40. The cable connector head 40 has a cable 41, wherein the cable 41 is inserted through the cable connector for decreasing signal return loss 1 via the second hole 23 of the base 20. More particularly, the cable 41 is inserted into the clamping hole 34 formed by the first clamping piece 311, the second clamping piece 312, the third clamping piece 313, and the fourth clamping piece 314. The cable 41 forcefully stretches the clamping hole 34 open, thereby making the cable fixed in place in the clamping hole 34, elastically pressed by the first clamping piece 311, the second clamping piece 312, the third clamping piece 313, and the fourth clamping piece 314 from four sides, hence being clamped in the middle of the clamping hole 34. Thus the cable connector for decreasing signal return loss 1 is able to connect with the cable connector head 40, transmitting electric signals to each other.

When the cable 41 is clamped in the clamping hole 34, the cable 41 is electrically connected with the first clamping piece 311, the second clamping piece 312, the third clamping piece 313, and the fourth clamping piece 314. An electric signal from the cable 41 would be able to flow through the first clamping piece 311, the second clamping piece 312, the third clamping piece 313, and the fourth clamping piece 314 to the wire connection part 32. The electric signal then is able to flow from the wire connection part 32 to the lead part 33 through a linking part 331. The linking part 331 links the wire connection part 32 and the lead part 33 together.

The following compares and contrasts the cable connector for decreasing signal return loss 1 before and after connecting the cable connector head 40.

With reference to FIG. 5A and FIG. 7, before the cable 41 enters the clamping hole 34, a gap 26 is formed between the back parts 317 of the clamping pieces 311, 312, 313, 314 and the bottom of the second mounting recess 24, creating a gap distance R1 between the back parts 317 and the bottom of the second mounting recess 24.

With further reference to FIG. 8, a diameter of the clamping hole 34 can be smaller than a diameter of the cable 41. When the cable 41 is getting clamped in the clamping hole 34, the cable 41 stretches the clamping hole 34 open, the back parts 317 contact and roll along an inner surface of the second mounting recess 24 of the base 20, and the back parts 317 tilt less with respect to the middle parts 316.

With reference to FIG. 9, when the cable 41 is getting clamped in the clamping hole 34, a gap distance R2 is created between the back parts 317 of the clamping pieces 311, 312, 313, 314 and the bottom of the second mounting recess 24. The gap distance R2 is less than the gap distance R1, meaning the gap distance R1 in FIG. 5A symbolizes an elastic deformation that the first clamping piece 311, the second clamping piece 312, the third clamping piece 313, and the fourth clamping piece 314 would be able to bear. When the cable 41 is clamped in the clamping hole 34, the gap distance R2 in FIG. 9 would change according to the diameter of the cable 41. The bigger the diameter of the cable 41 is, the more the first clamping piece 311, the second clamping piece 312, the third clamping piece 313, and the fourth clamping piece 314 would deform, decreasing the gap distance R2, enabling the cable connector for decreasing signal return loss 1 to adapt to the cable 41 of different dimensions better. Additionally, by having the first clamping piece 311, the second clamping piece 312, the third clamping piece 313, and the fourth clamping piece 314 clamping the cable 41 together, the cable 41 can be better fixed in place connecting to the present invention, better stabilizing a cable connection, and improving connection quality.

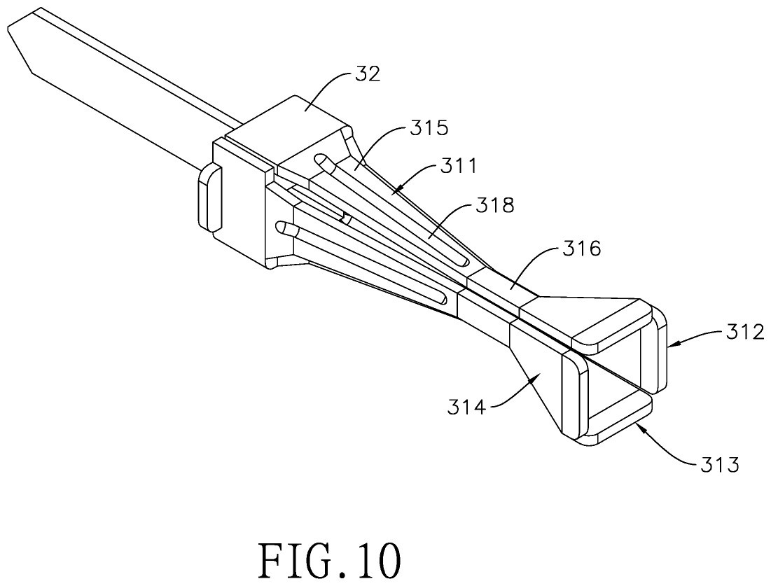

With reference to FIG. 10, in a second embodiment of the present invention, a groove 318 is respectively formed between the front parts 315 of each of the clamping pieces 311, 312, 313, 314. The groove 318 extends from the wire connection part 32 towards the middle parts 316 of each of the clamping pieces 311, 312, 313, 314. The groove 318 allows more deformation from the first clamping piece 311, the second clamping piece 312, the third clamping piece 313, and the fourth clamping piece 314. In the second embodiment of the present invention, such deformations can form on an outer surface of the first clamping piece 311, the second clamping piece 312, the third clamping piece 313, and the fourth clamping piece 314. Alternatively, the deformations can form on an inner surface of the first clamping piece 311, the second clamping piece 312, the third clamping piece 313, and the fourth clamping piece 314 as well in another embodiment of the present invention.

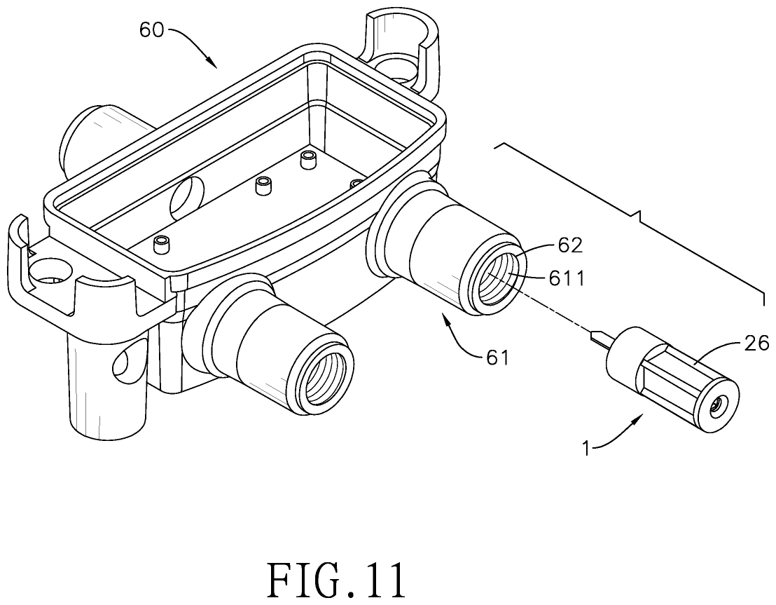

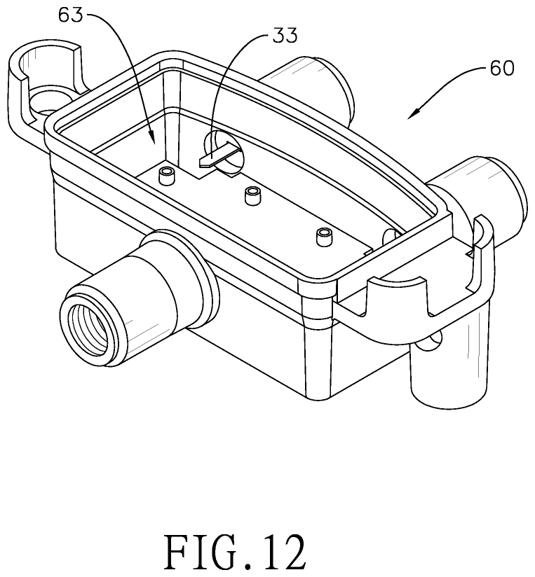

With reference to FIG. 11 and FIG. 12, in an exploded view of a second application of the first embodiment of the present invention, the cable connector for decreasing signal return loss 1 is applied to a signal divider 60 of a television. The signal divider 60 has multiple signal ports 61. Each of the signal ports 61 has an opening 62, and inside the opening 62 each of the signal ports 61 has some threads 611.

The cable connector for decreasing signal return loss 1 is mounted in the opening 62 of the signal divider 60. Once mounted, the lead part 33 as a flat piece would be able to reach an internal space 63 of the signal divider 60 for transmitting electric signals between different electronic devices. The connecting terminal 30 as a whole can be manufactured with metallic materials.

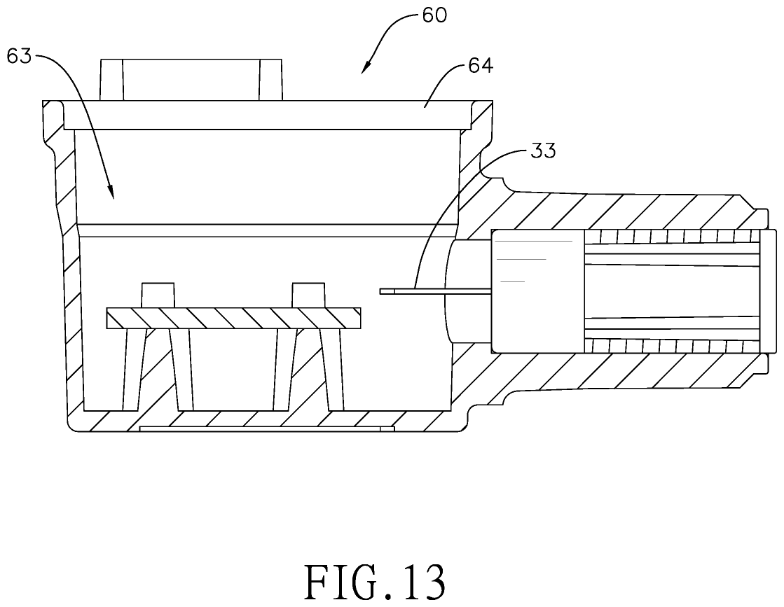

With reference to FIG. 13, the signal divider 60 has a circuit cap 64 to isolate the internal space 63 of the signal divider 60. Since the signal divider 60 and the circuit cap 64 are metallic, the internal space 63 of the signal divider 60 is like an inside of a Faraday cage, allowing electric signals to be transmitted by the lead part 33 without electromagnetic influences from outside. FIGS. 6, 7, and 8 serve as an example of how the first embodiment of the present invention can be applied to a device in practice, rather than a limitation of devices the present invention can be applied to.

With reference to FIG. 2 and FIG. 3, on the base 20 of the first embodiment of the present invention, multiple ribs 26 are mounted between the second front side 21 and the second back side 22, and formed on a side surface 27 of the base 20. Between any two adjacent ones of the ribs 26, an isolating space is created. When the cable connector for decreasing signal return loss 1 is connected with the signal divider 60, the isolating space would create an isolating barrier of air against conducting components. With air isolating the conducting components, the electric signals can be less affected by surrounding solid materials, ensuring better signal transmission qualities. This way regardless of what electrical conductivity and heat conductivity the surrounding solid materials have, air is always a good material for electrical isolation.

With reference to FIG. 11 and FIG. 12, the cable connector for decreasing signal return loss 1 is connected with the signal divider 60 in the first application of the first embodiment of the present invention, despite the side surface 27 of the base 20 has the ribs 26 rather than corresponding threads for the threads 611 inside the signal port 61. This is possible as once the cable connector for decreasing signal return loss 1 is shoved into the signal port 61, the circuit cap 64 would be wielded shut after the inside 63 of the signal divider 60 is correctly wired. Such wielding heat would cause the metallic signal divider 60 to expand slightly in size, and tightly fix the cable connector for decreasing signal return loss 1 in place by squeezing the cable connector for decreasing signal return loss 1 slightly as the signal port 61 expands inward, narrowing the opening 62.

In conclusion, the back parts 317 of each of the first clamping piece 311, the second clamping piece 312, the third clamping piece 313, and the fourth clamping piece 314 of the present invention are free to move without any bending structures. Compared to a conventional cable connector, the present invention is able to avoid potential capacitance built up in bending structures, and therefore avoids a potential capacitor from affecting signal transmissions between electronic devices. Additionally, in the present invention the first clamping piece 311, the second clamping piece 312, the third clamping piece 313, and the fourth clamping piece 314 would clamp the cable 41 simultaneously, stabilizing the connection between the cable 41 and the cable connector for decreasing signal return loss 1, and improving an overall connection quality.

What is claimed is:

1. A cable connector for decreasing signal return loss, comprising:
a front cap, having a first hole, a first front side and a first back side;
a base, having a second front side and a second back side; wherein the second back side of the base has a second hole, and the second front side of the base is connected to the first back side of the front cap;
a connecting terminal, further comprising:
a clamping part, having a front side and a back side; wherein the clamping part is elastic, and the back side of the clamping part is a free end;
a wire connection part, having a front side, and connecting the front side of the clamping part; and
a lead part, having a back side and mounted on the front side of the wire connection part to connect the wire connection part;
wherein the connecting terminal is mounted inside the base; the front cap is mounted on the base and the connecting terminal; and the lead part is inserted through the first hole to extend out of the first front side of the front cap.

2. The cable connector as claimed in claim 1, further comprising:
a first mounting recess, formed on the first back side of the front cap; wherein the first mounting recess is connected with the first hole, and the second front side of the base is mounted in the first mounting recess.

3. The cable connector as claimed in claim 1, further comprising:
a second mounting recess, formed on the second front side of the base; wherein the second mounting recess is connected to the second hole, and the clamping part of the connecting terminal and the wire connection part are mounted in the second mounting recess.

4. The cable connector as claimed in claim 3, further comprising:
a gap, formed between the clamping part and a bottom surface of the second mounting recess.

5. The cable connector as claimed in claim 1, wherein the clamping part further comprises a first clamping piece, a second clamping piece, a third clamping piece, and a fourth clamping piece, and each of the first to fourth clamping pieces comprises:
a front part, connecting the wire connection part;
a middle part, connecting a back end of the front part; and
a back part, connecting a back end of the middle part;
wherein the front part and the back part are mounted at a tilting angle with respect to the middle part, the front part tilts toward the middle part from the wire connection part, and the back part tilts toward the middle part from the second hole.

6. The cable connector as claimed in claim 5, wherein the first clamping piece and the third clamping piece are located opposite to each other;
wherein the second clamping piece and the fourth clamping piece are also located opposite to each other; and
wherein the first clamping piece, the second clamping piece, the third clamping piece, and the fourth clamping piece are elastic pieces.

7. The cable connector as claimed in claim 5, wherein the middle parts of each of the first clamping piece, the second clamping piece, the third clamping piece, and the fourth clamping piece together form a clamping hole.

8. The cable connector as claimed in claim 1, further comprising:
a bending part, formed on the back side of the lead part, and connected to an edge of the front side of the wire connection part.

9. The cable connector as claimed in claim 7, wherein the first hole, the wire connection part, the clamping hole, and the second hole are aligned.

10. The cable connector as claimed in claim 1, further comprising:
a locking part, protruding from an edge of the front side of the wire connection part;
wherein the locking part is mounted between the front cap and the base.

11. The cable connector as claimed in claim 5, further comprising:
a groove, formed on the front part;
wherein the groove extends from the wire connection part towards the middle part.

12. The cable connector as claimed in claim 5, wherein a diameter of the front part is bigger than a diameter of the middle part;
wherein the diameter of the front part gradually decreases from the wire connection part towards the middle part.

13. The cable connector as claimed in claim 5, wherein a diameter of the back part is bigger than the diameter of the middle part;
wherein the diameter of the back part gradually decreases from the second hole towards the middle part.

14. The cable connector as claimed in claim 5, further comprising:
a front space, surrounded by the front parts of the first to fourth clamping pieces;
wherein the front space expands gradually from the middle part towards the wire connection part.

15. The cable connector as claimed in claim 5, further comprising:
a back space, surrounded by the back parts of the first to fourth clamping pieces; and
wherein the back space expands gradually from the middle part towards the second hole.

16. The cable connector as claimed in claim 1, further comprising:
multiple ribs, located between the second front side and the second back side on a side surface of the base;
wherein between any two adjacent ones of the ribs and the second back side, an isolating space is created.
